(19) United States
(12) Patent Application Publication
(10) Pub. No.: US 2009/0320645 A1
(43) Pub. Date: Dec. 31, 2009

(54) Anti-Caking Agent

(76) Inventors: Yusuke Baba, Kanagawa-ken (JP); Minoru Yaguchi, Kanagawa-ken (JP)

Correspondence Address: CURATOLO SIDOTI CO., LPA, 24500 CENTER RIDGE ROAD, SUITE 280, CLEVELAND, OH, 44145, US

(21) Appl. No.: 12/304,367

(22) PCT Filed: May 26, 2007
(86) PCT No.: PCT/EP2007/004710

§ 371 Date: Jul. 8, 2009

(30) Foreign Application Priority Data
Jun. 26, 2006 (JP) 2006 175036
Jul. 20, 2006 (JP) 2006 198584

(51) Int. Cl. C09K 3/00

(52) U.S. Cl. 75/330; 252/384

(57) ABSTRACT

The present invention relates to providing anti-caking agent and additive for granulated blast furnace slag or mechanically stabilized product thereof.

The anti-caking agent of the present invention contains component A: gluconic acid and/or a salt thereof, and component B: copolymer and/or a salt thereof of C₅₋₆ chained olefin and one or more monomers selected from maleic anhydride, maleic acid or their esterified product, (meth)acrylic acid or its esterified product. The additive of the present invention contains component (I): an anti-caking agent for granulated blast furnace slag, and component (II): an anti-foaming agent selected from one or more kinds based on block and/or random copolymer of polyethylene oxide and propylene oxide, silicone, mineral oil, alcohol, fatty acid ester, and polyether.

The present invention concerns an anti-caking agent and an additive for granulated blast furnace slag or a mechanically stabilized product thereof.

Granulated blast furnace slag is the glassy (amorphous) granulates obtained by rapidly cooling the molten slag obtained as a by-product in a blast furnace for producing pig iron by injecting pressurized water thereto. A mechanically stabilized product of the granulated blast furnace is a product obtained by adjusting the grain size of said granulated blast furnace slag to a prescribed size. The granulated blast furnace slag and the mechanically stabilized product thereof will be hereinafter collectively called “granulated blast furnace slag” in the present specification. The feature of the granulated blast furnace slag is in containing almost no dirt, mud, organic impurities, chlorides, etc. It is therefore used in recent years as the fine aggregates for construction work materials and cement compositions such as mortar and concrete, and it is also used as the fine aggregates of granulated blast furnace slag from the viewpoint of the highly recycling-based society system for the symbiosis with the environment.

On the other hand, granulated blast furnace slag is known to produce clods caused by the consolidation of its granulates after a certain period of storage in a stockyard or during transportation by sea, etc. because of its glassiness and latent hydraulic property. This consolidation is more noticeable during hot seasons, where consolidation is apt to occur in a shorter period of time. This problem lays a heavy restraint to the use of the granulated blast furnace slag as the resources for aggregates. Several techniques for solving this important problem in the handling of granulated furnace blast slag have been developed (cf. Patent Documents 1 to 8 for example), but no sufficiently effective method for preventing the consolidation has been developed so far.

In the preparation of cement compositions such as mortar and concrete using the granulated blast furnace slag as the fine aggregate, excessive amount of entrapped air, i.e. relatively large air foams (more than 100 μm), was apt to be mixed during kneading, and the amount of said entrapped air tend to 1.4 to 3.5% more than the case using river (land) sand. JIS-standard ready-mixed concrete, etc. are in general produced with various blend/mix depending on the purpose of its use, but since the air content is limited from the viewpoint of workability and durability, AE agent or air-content controlling agent is added to the product at the time of its production in order to control the air content. When producing concrete through batch production, however, the amount of mixed air differs greatly depending on the used material, blend/mix, and production method, and the control of the air content was complicated and difficult especially when using granulated blast furnace slag, in which entrapped air is tend to get mixed in an excessive amount. Furthermore, the foams of entrapped air are easy to break since the foams of entrapped air have less stability comparing to those of entrained air (independent micro air foams of good quality (normally about several ten to 100 μm) that are entrained by AE agent, etc.). Therefore, fresh concrete using granulated blast furnace slag as the fine aggregates had the problem of fluctuating quality that the air content was apt to decrease with the lapse of time due to entrapped air.

[Patent Document 1]
JP Patent Application Disclosure No. 54-130496

[Patent Document 2]
JP Patent No. 3559204

[Patent Document 3]
JP Patent Application Disclosure No. 54-096493

[Patent Document 4]
JP Patent Application Disclosure No. 56-078624

[Patent Document 5]
JP Patent Application Disclosure No. 57-088046

[Patent Document 6]
JP Patent Application Disclosure No. 2003-160364

[Patent Document 7]
JP Patent Application Disclosure No. 2003-306357

[Patent Document 8]
JP Patent Application Disclosure No. 2004-099389

The object of the present invention is to provide a novel anti-caking agent for granulated blast furnace slag with sufficient anti-caking effect and an additive for granulated blast furnace slag for preventing the consolidation thereof and preventing the excessive amount of entrapped air of the cement composition obtained when using said slag as the fine aggregates from getting mixed into the cement composition.

The inventors of the present invention made exhaustive studies to solve the aforementioned problem, and succeeded in discovering a novel anti-caking agent for granulated blast furnace slag with sufficient anti-caking effect by using together 2 components of particular kinds. The inventors further succeeded in discovering an additive for granulated blast furnace slag for preventing the consolidation thereof and preventing the excess amount of entrapped air of the cement composition obtained when using said slag as the fine aggregates from getting mixed into the cement composition.

The anti-caking agent of the present invention is characterized by containing components A and B below, and is useful for granulated blast furnace slag or a mechanically stabilized product thereof.

Component A: gluconic acid and/or a salt thereof.

Component B: copolymer and/or a salt thereof of C₅₋₆ chained olefin and one or more monomers selected from maleic anhydride, maleic acid or their esterified product, (meth)acrylic acid or its esterified product

The anti-caking agent of the present invention is characterized in that the mass ratio of said component A to component B is 90:10 to 50:50.

The anti-caking agent of the present invention is characterized in that said component B is a copolymer with a number average molecular weight of 1000 to 300000 and/or a salt thereof.

The method for preventing the consolidation according to the present invention is applicable to granulated blast furnace slag or a mechanically stabilized product thereof, and is characterized by using an anti-caking agent containing components A and B below in an amount of 0.001 to 0.1 part by weight based on 100 parts by weight of the granulated blast furnace slag or the mechanically stabilized product thereof.

Component A: gluconic acid and/or a salt thereof.

Component B: copolymer and/or a salt thereof of C₅₋₆ chained olefin and one or more monomers selected from maleic anhydride, maleic acid or their esterified product, (meth)acrylic acid or its esterified product

The method for preventing consolidation according to the present invention is characterized by using 0.01 to 10% by weight aqueous solution of the aforementioned anti-caking agent.

The present invention further concerns granulated blast furnace slag or a mechanically stabilized product thereof containing an anti-caking agent comprising components A and B below.

Component A: gluconic acid and/or a salt thereof.

Component B: copolymer and/or a salt thereof of C₅₋₆ chained olefin and one or more monomers selected from maleic anhydride, maleic acid or their esterified product, (meth)acrylic acid or its esterified product

The additive of the present invention is characterized by containing components (I) and (II) below, and is useful for granulated blast furnace slag or a mechanically stabilized product thereof.

Component (I): anti-caking agent for granulated blast furnace slag

Component (II): one or more kinds of anti-foaming agent selected from those based on block and/or random copolymer of polyethylene oxide and propylene oxide, silicone, mineral oil, alcohol, fatty acid ester, and polyether

The present invention also concerns a method for preventing excess air entrapment from getting mixed into cement composition, characterized by using an additive containing components (I) and (II) below.

Component (I): anti-caking agent for granulated blast furnace slag

Component (II): one or more kinds of anti-foaming agent selected from those based on block and/or random copolymer of polyethylene oxide and propylene oxide, silicone, mineral oil, alcohol, fatty acid ester and polyether.

By using the anti-caking agent of the present invention, the consolidation that occurred during storage in a stockyard or during transportation by sea, etc., which had been a serious obstacle to the effective use of granulated blast furnace slag as the resources for aggregates, can be prevented for a long period of time. Another advantage of the anti-caking agent of the present invention, when it is used within a normal usage effective for preventing consolidation, is in that it can be added to granulated blast furnace slag without affecting the physical properties of the cement composition when using said slag as its fine aggregates. The present invention expands the effective use of the granulated blast furnace slag as the resources for aggregates, and contributes to the construction of the highly recycling-based society system for the symbiosis with the environment. Furthermore, the hard labor of crushing the consolidation with heavy machinery will no longer be necessary with the present invention, and therefore the present invention contributes to the reduction of cost and energy as well.

By using the additive for granulated blast furnace slag of the present invention, the consolidation of the granulated blast furnace slag and the excessive air entrapment in the cement composition obtained by using said slag as the fine aggregates can be prevented at the same time, and the complicated operation of controlling air content in the ready-mixed concrete factories can be remarkably facilitated.

The present invention shall be further explained based on the preferable embodiments of the invention.

### (Anti-Caking Agent for Granulated Blast Furnace Slag)

### Granulated Blast Furnace Slag

There is no particular limitation to the definition of the granulated blast furnace slag of the present invention, and it means the granulated blast furnace slag obtained by rapidly cooling the high-temperature molten slag (blast furnace slag) produced in the steel industry by injecting high-pressure water to consolidate the slag into sand-like product and the products obtained by mechanically stabilizing its grain size. The obtained particles are glassy, and have the chemical composition mainly comprising of lime and silica.

### Component A

The anti-caking agent for granulated blast furnace slag of the present invention exhibits remarkable anti-caking action to the granulated blast furnace slag by using two kinds of components in combination. To be more precise, said two kinds of components are components A and B below.

Component A is gluconic acid and/or a salt thereof. Here, there is no particular limitation to the salt of the gluconic acid, and alkali metal ions, alkali earth metal ions, or various basic organic compounds can be selected according to the respective conditions for the application to the granulated blast furnace slag. When using the anti-caking agent for granulated blast furnace slag in a form of an aqueous solution, it is preferable that component A be a water-soluble salt, especially a sodium salt.

A natural product or a synthesized product can be equally used as component A. It is possible to use a commercial product as it is. The preferable range of the purity of component A is 90 to 100%.

### Component B

Component B is a copolymer comprising the following monomers. The first monomer is one or more kinds of monomers selected from maleic anhydride, maleic acid or their esterified product, (meth)acrylic acid or its esterified product, and the second monomer is C₅₋₆ chained olefin. Component B further contains the salt of said copolymer. In the present specification, the term (meth)acrylic acid is used to mean methacrylic acid and other substituted acrylic acids as well.

As the second monomer, pentene-1, pentene-2,2-methyl-butene-1,2-methyl-butene-2,4-methyl-pentene-2, hexene-1, etc. and the mixture thereof can be preferably used as the C₅₋₆ chained olefin.

There is no limitation to the esterified products of maleic acid and (meth)acrylic acid, but the preferable example thereof is an ester of maleic acid or (meth)acrylic acid and C₁₋₅ alkyl, methoxy, ethoxy, or butoxy alkylene glycol ether (n=1 to 99, wherein n is an integer representing the number of alkylene glycol), and the most preferable example is an ester of maleic acid or (meth)acrylic acid and C₁₋₃ alkyl, methoxy, ethoxy, or butoxy polyethylene glycol ether.

Maleic anhydride, maleic acid or their esterified product, (meth)acrylic acid or its esterifed product can be produced through a conventional method, and it is also possible to use a commercial product as it is.

There is no limitation to the method for obtaining component B by copolymerizing the aforementioned monomers, and a conventional polymerization method can be employed. Through the polymerization, the microstructure of each monomer, such as the abundance ratio, regularity, stereostructure, etc. can be modified desirably.

It is further possible to adjust the molecular weight of the copolymer within a desirable range. The molecular weight of component B in the present invention is preferably between a number average molecular weight of 1000 and 300000, more preferably between 2000 and 200000. Sufficient anti-caking effect cannot be achieved when the molecular weight is beyond said range, and it is not preferable for the molecular weight to be too big, since it increases the viscosity and makes the even spraying to the granulated blast furnace slag difficult.

Here, there is no limitation to the abundance ratio of the first monomer and the second monomer in component B, but it is preferable that the amount of the first monomer is within the range of 40 to 60 mol %. It is not preferable for the proportion of the first monomer to be beyond said range, since a sufficient anti-caking effect cannot be achieved.

There is no limitation to the preparation method of the salt of the polymer, and it is possible to obtain the salt in a solid state by preparing a polymer an then neutralizing the same by using a suitable base. In preparing an aqueous solution containing components A and B, it is possible to neutralize the polymer solution at the time of the preparation by using a suitable base. Hydroxides of alkali metals such as sodium, potassium, lithium, etc. and alkali earth metals such as calcium, magnesium, etc., or water-soluble organic amines such as ammonium, triethanolamine, diethanolamine, etc. can be used as the base for neutralizing said copolymer, but it is preferable to use the hydroxide of sodium.

There is no limitation to the abundance ratio of said components A and B in the anti-caking agent of the present invention, and it can be decided according to the kinds and physical properties of the granulated blast furnace slag. It is preferable that the amount of component A is at least 50 mass %, more preferably 90 mass %.

The anti-caking agent of the present invention is a solid mixture of components A and B or a solution obtained by using a suitable solvent, but products obtained by adding various additives thereto in an amount that would not affect the anti-caking effect thereof can also be included therein. The examples of such additives are saccharides, sugar alcohol, lignin sulfonic acid, phosphonic acid, etc.

### (Method for Preventing Consolidation)

The method for preventing consolidation according to the present invention is a method for preventing the consolidation of granulated blast furnace slag or a mechanically stabilized product thereof. To be more precise, an anti-caking agent containing components A and B below is used in the present method in a proportion of 0.001 to 0.1 part by weight based on 100 parts by weight of the granulated blast furnace slag or the mechanically stabilized product thereof. Here, component A is gluconic acid and/or a salt thereof and component B is a copolymer and/or a salt thereof of C₅₋₆ chained olefin and one or more monomers selected from maleic anhydride, maleic acid or their esterified product, (meth)acrylic acid or its esterified product. The particulars of components A and B are as explained above.

There is no limitation to the method for using said components A and B for granulated blast furnace slag. When adding said components to the granulated blast furnace slag, the timing, adding order, and the pretreatment of the additive can be suitably selected according to the circumstances. The timing for adding components A and B to the granulated blast furnace slag can be immediately before its use, or any other suitable time before its use. Said components can be added to the slag by adding component B after adding component A, by adding component A after adding component B, or by adding components A and B at approximately the same time. Each component can be mixed into the granulated blast furnace slag in a form of lump-like solids, fluid, powder, or by preparing a solution by dissolving said components into a suitable solvent and then spray-mixing said solution with the slag. There is no particular limitation to the amount of components A and B to be mixed, and it can be suitably adjusted according to the properties, conditions and period of storage, etc. of the granulated blast furnace slag. The weight percentage of components A and B to the granulated blast furnace slag (absolute dry) is preferably within the range of 0.001 to 0.1% by weight. Sufficient effect cannot be obtained when the amount is below said range, and the effect hits the ceiling and becomes uneconomical when the amount exceeds said range.

It is preferable to use a 0.01 to 10% by weight aqueous solution of the anti-caking agent. Sufficient long-term anti-caking effect cannot be achieved when the amount is below said range, and the spraying to the granulated blast furnace slag becomes uneven when the amount exceeds said range.

### (Granulated Blast Furnace Slag)

The granulated blast furnace slag of the present invention contains an anti-caking agent containing components A and B below. Component A is gluconic acid and/or a salt thereof, and component B is a copolymer and/or a salt thereof of C₅₋₆ chained olefin and one or more monomers selected from maleic anhydride, maleic acid or their esterified product, (meth)acrylic acid or its esterified product.

The granulated blast furnace slag of the present invention is an outstandingly superior granulated blast furnace slag that would not get consolidated for a long period of time under ordinary storage conditions. The period until consolidation depends on the storage conditions (temperature, humidity, pressure, etc.), but the granulated blast furnace slag of the present invention can be stored without getting consolidated for a few to several ten times longer than the conventional granulated blast furnace slag.

### (Additive)

The additive of the present invention is used for granulated blast furnace slag or a mechanically stabilized product thereof, and characterized by containing component (II) below. Furthermore, the additive of the present invention is used for granulated blast furnace slag or a mechanically stabilized product thereof, characterized by containing components (I) and (II) below. Component (I) is an anti-caking agent for granulated blast furnace slag and component (II) is an anti-foaming agent selected from one or more kinds of those based on block and/or random copolymer of polyethylene oxide and polypropylene oxide, silicone, mineral oil, alcohol, fatty acid ester, and polyether.

### Granulated Blast Furnace Slag or a Mechanically Stabilized Product

The additive of the present invention is applicable to the granulated blast furnace slag or a mechanically stabilized product with the aforementioned definition.

### Component (I):

Any product known as a conventional anti-caking agent for granulated blast furnace slag in the relevant technical field can be used without limitation as component (I) of the present invention. To be more precise, the examples of component (I) of the present invention are aliphatic oxycarboxylic acid or its salt, alkylene oxide adduct of aliphatic oxycarboxylic acid or its salt, alkylene oxide adduct of aliphatic oxycaroxylate, saccharides, sugar alcohol, lignin sulfonic acid or its salt, carboxyl-group-containing polymer, phosphonic acid derivative, water-insoluble and water-absorbing acrylic acid-based cross-linked polymer, aerated water, and carbonate. The use of the anti-caking agent for granulated blast furnace of the present invention is also preferable. There is no limit to the amount of component (I) to be used, but it is typically preferable to use 0.001 to 0.3% by mass of component (I) based on the absolute dry weight of the granulated blast furnace slag.

### Component (II):

Any product known as a conventional anti-foaming agent in the relevant technical field can be used as component (II) of the present invention, but it is preferable to use one or more kinds of anti-foaming agents selected from those based on block and/or random copolymer of polyethylene oxide and polypropylene oxide, silicone, mineral oil, alcohol, aliphatic ester, and polyether.

Here, the preferable silicone-based anti-foaming agents are dimethyl silicone oil, silicone paste, silicone emulsion, organic modified polysiloxane (polyorganosiloxane such as dimethyl polysiloxane, etc.), and fluorosilicone oil. The preferable mineral oil-based anti-foaming agents are kerosene and liquid paraffin. The preferable alcohol-based anti-foaming agents are octylalcohol, hexadecyl alcohol, acetylene alcohol and glycols. The preferable aliphatic acid ester-based anti-foaming agents are glycerin monoricinolate, alkenyl succinic acid derivatives, sorbitol monolaurate, sorbitol trioleate, and natural wax. The preferable polyether-based anti-foaming agents are polyoxyalkylenes such as polyoxyethylene polypropylene adduct, etc., polyoxyalkylene alkyl ethers obtained by partially etherifying the terminal group of polyoxyalkylenes with alkyl group, polyoxyalkylene (alkyl) aryl ethers obtained by partially etherifying the terminal group of polyoxyalkylenes with aryl group or alkyl aryl group, polyoxyalkylene aliphatic acid esters obtained by partially aliphatic-acid-esterifying the terminal group of polyoxyalkylenes, polyoxyalkylene (alkyl) aryl ether sulfate salts obtained by partially sulfating the terminal group of polyoxyalkylenes, and polyoxyalkylenes such as polyoxyalkylene alkylamines obtained by partially aminating the terminal group of polyoxyalkylenes.

In the present invention, the use of silicone-based anti-foaming agents, to be more precise dimethyl silicone oil, silicone paste, and silicone emulsion, is especially preferable.

For example, ADEKA Pluronic L-61 (manufactured by K.K. ADEKA) can be used as the block copolymer of polyethylene oxide and polypropylene oxide of the present invention, SN-540E (manufactured by San Nopco K.K.) can be used as the silicone-based compound, Adekanol LG-150 (manufactured by K.K. ADEKA) can be used as the mineral oil-based compound, SN defoamer 573 (manufactured by San Nopco K.K.) can be used as the alcohol-based compound, DF-180 (manufactured by Miyoshi Yushi K.K.) can be used as the aliphatic acid ester-based compound, and SN defoamer 170 (manufactured by San Nopco K.K.) can be used as the polyether-based compound.

There is no limit to the content of component (II) as long as it is within the amount that contributes to the prevention of the mixture of excessive entrapped air in the cement composition produced by using the granulated blast furnace slag of the present invention as the fine aggregates, but it is preferable to use 0.0001% by mass or more, more preferably 0.0005% by mass or more of component (II) based on the absolute dry weight of the granulated blast furnace slag. When the content (used amount) of component (II) is too small, sufficient prevention of the mixture of excessive entrapped air during the kneading of the cement composition using the granulated blast furnace slag of the present invention as the fine aggregates becomes difficult.

There is no limit to the abundance ratio of components (I) and (II) in the additive of the present invention and it can be decided according to the kind and physical property of the granulated blast furnace slag. It is preferable for the amount of component (I) to be at least 0.001% by mass.

The additive of the present invention is a solid mixture of components (I) and (II) or a solution obtained by using a suitable solvent, but it includes those to which various additives are added within the amount that would not damage its effect.

### (Method for Preventing Excess Air Entrapment in a Cement Composition)

Excessive mixture of air entrapment in a cement composition can be effectively prevented by using the additive of the present invention. There is no limit to the method of using the present additive, and conventional adding methods and adding apparatus can be preferably used.

There is no limit to the added amount of the additive of the present invention, and the amount can be optimized according to the cement composition. To be more precise, it is preferable to mix the additive of the present invention into granulated blast furnace slag. Equal effect can be achieved by adding component (II) alone as well, and therefore it is also preferable to use component (II) alone.

The present invention will be further explained through the embodiments of the present invention.

### EXAMPLE

The present invention will be further explained through examples and comparative examples of the invention, but the present invention is not limited to these examples.

### (1) Materials Used in the Experiment

Granulated blast furnace slag: granulated blast furnace slag fine aggregates manufactured by Kimitsu Seitetsujo of Shin-Nihon Seitetsu K.K. (qualified product of JIS A 5011-1: 1997 “slag aggregate for concrete, Part 1: blast furnace slag aggregate”, density: 2.76 g/cm³, water-absorption: 2.01%, percentage to be collected in a 5 mm sieve: 0%) was used.

Anti-caking agent for granulated blast furnace slag and additive for granulated blast furnace slag: those shown in Tables 1 and 2 were used.

Cement: normal Portland cement manufactured by Taiheiyo Cement K.K. was used.

TABLE 1

| | Anti-caking agent for granulated blast furnace slag | | |
|---|---|---|---|
| | Kind of component | | Mixing ratio of A:B |
| code | A | Kind of component B | (mass %) |
| y-1 | A-1 | B-1 | 70:30 |
| y-2 | A-2 | B-1 | 100:0 |
| y-3 | | | 95:5 |
| y-4 | | | 70:30 |
| y-5 | | | 60:40 |
| y-6 | | | 40:60 |
| y-7 | | | 0:100 |
| y-8 | A-2 | B-2 | 70:30 |
| y-9 | A-2 | B-3 | 70:30 |
| y-10 | A-2 | B-4 | 70:30 |
| y-11 | A-2 | B-5 | 70:30 |

In Table 1,
A-1: gluconic acid
A-2: gluconic acid sodium
B-1: Sodium salt of a copolymer of maleic anhydride and 2-methyl-butene-1, number average molecular weight: 3000
B-2: Sodium salt of a copolymer of maleic anhydride and 2-methyl-butene-1, number average molecular weight: 5000
B-3: Sodium salt of a copolymer of ethylene oxide adduct of maleic acid and 2-methyl-butene-1, number average molecular weight: 5000
B-4: Sodium salt of a copolymer of acrylic acid and hexene-1, number average molecular weight: 6000
B-5: Sodium salt of a copolymer of ethylene oxide adduct of acrylic acid and hexene-1, number average molecular weight: 6000

TABLE 2

| | Additive for granulated blast furnace slag | |
|---|---|---|
| | Kind of anti-caking agent for | |
| code | granulated blast furnace slag | Kind of anti-foaming agent |
| z-1 | y-4 | C-1 |
| z-2 | | C-2 |
| z-3 | | C-3 |

In Table 2,
C-1: Block copolymer of polyethylene oxide and polypropylene oxide (ADEKA Pluronic L-61, manufactured by K.K. ADEKA)
C-2: Silicone-based compound (SN-540E manufactured by San Nopco K.K.)
C-3: Mineral oil-based compound (ADEKANOL LG-150 manufactured by K.K. ADEKA)

### (2) Preparation Method of Samples

The moisture content of the granulated blast furnace slag was adjusted to approximately 3% before use. The anti-caking agent and the additive were used in the amount shown in Table 1 based on the absolute dry weight of the granulated blast furnace. Solutions of the anti-caking agent and the additive were prepared by diluting the same with top water so that the moisture content of the granulated blast furnace slag after the addition of the anti-caking agent or the additive would be 10%, and the solutions were sprayed to the granulated blast furnace slag. Then the granulated blast furnace was mixed and stirred with a mortar mixer (ASTM method, low-speed) for 5 minutes, and the obtained evenly mixed slag was used as the samples.

### (3) Preparation Method of Specimens and Production Method of Mortar

### 1) Method for the Preparation of the Specimens for the Evaluation Test of Anti-Caking Performance

The specimens were prepared by filling a steel mold with a diameter of 50 mm and a height of 10 mm with 240 g of granulated blast furnace slag with a moisture content of 10%, dropping the same for 20 times using a flow table, and then compacting the same by loading thereto a pressure of 0.15N/mm².

The load of pressure was applied to the specimen by using a uniaxial compression tester specified under JIS A 1216: 1998 “Method for uniaxial compression test of soil”. After unloading, the upper surface was sealed with wrap film and aluminum foil adhesive tape to avoid water from escaping, and then the specimen was aged until the specimen age (1, 7, 14, 28, and 56 days) by letting it still in a thermo-hygrostat bath of 60° C. and 90% R.H.

### 2) Method for the Production of the Mortar for the Evaluation Test of Air-Entrapment-Preventing Property

Mortar was obtained by kneading a mass ratio of cement 1, granulated blast furnace slag (saturated surface-dried condition) 3, and a water-cement ratio of 0.55 according to JIS R 5201: 1997 “testing method for physical properties of cement”.

The granulated blast furnace slag with a moisture content of 10% prepared according to the aforementioned “(2) Preparation method of samples” was used, and the amount of mixing water was adjusted according to the percentage of surface moisture of the granulated blast surface slag.

### (4) Tested Items and Testing Method

### 1) Evaluation of the Degree of Consolidation of the Specimen and Measurement of the Prevention Rate of Consolidation

The degree of consolidation was evaluated according to JIS A 5011-1: 1997 “slag aggregate for concrete, Part 1: blast furnace slag aggregate, attached document 2 (reference) testing method of the storage stability of blast furnace slag fine aggregate” after demolding the specimen from the steel mold at the prescribed specimen age.

After evaluating the degree of consolidation, the mass of the samples that passed through 5 mm sieve was measured to calculate the consolidation-prevention rate. The particulars of this test are as follows. Only the mass that passed through 5 mm sieve was measured for the specimens whose consolidation could not be confirmed during a visual observation at the time of demolding, and the evaluation test for the degree of consolidation was not carried out.

(i) The demolded specimen was put on a flow table, and submitted to dropping at a speed of 1 drop/second.

(ii) The degree of consolidation was evaluated according to the classification shown in Table 3 based on the number of dropping that was necessary for all the granulates to become about 10 mm or less. The number of dropping was 10 times in classification a and 40 times in classifications b and c, and the dropping was continued to the prescribed number even when all the granulates became 10 mm or less in the middle of the test.

TABLE 3

| Necessary number of dropping to | prescribed | |
|---|---|---|
| make the granulates about 10 mm | number of | |
| or less | dropping | classification |
| 0-10 | 10 | a |
| 11-40 | 40 | b |
| Impossible to crush all the granulates | 40 | c |
| into about 10 mm or less | | |
| even after dropping 40 times | | |

(iii) The consolidation prevention rate was calculated according to formula 1 by measuring the mass of the specimen that passed through 5 mm sieve after the dropping.

consolidation prevention rate (%)=mass that passed through 5 mm sieve (g)/240 (g)×100 [Formula 1]

### 2) Measurement of the Air Content of Mortar

The unit volume mass of the mortar was measured, and the air content was calculated according to JIS A 1116: 2005 “testing method of unit volume mass of fresh concrete and the testing method of air content by mass (mass method)”, “6. calculation of the result”.

### (5) Test Result

The test result is shown in Table 4. When using the anti-caking agent for granulated blast furnace slag of the present invention (Examples 1 to 11), a superior anti-caking effect could be achieved for a long period of time comparing to the cases using no anti-caking agent or using other anti-caking agents for granulated blast furnace slag (Comparative Examples 1 to 10). Furthermore, by using component B together with component A (Examples 2 and 3), remarkably superior anti-caking effect could be obtained comparing to the cases using each component alone (Comparative Examples 2 to 5, 8 to 10).

TABLE 4

| | Anti-caking agent for granulated blast furnace slag | | | | | | | | | | | |
|---|---|---|---|---|---|---|---|---|---|---|---|---|
| | | Used amount (S × %) | | | specimen | | | | | | | |
| | | Entire constitutive | | | | | | | Consolidation prevention | | | |
| | | component | | | Degree of consolidation | | | | rate (%) | | | |
| | | (component A + | | | 7 | 14 | 28 | 56 | 7 | 14 | 28 | 56 |
| | kind | component B) | Component A | Component B | days | days | days | days | days | days | days | days |
| Ex1 | y-1 | 0.020 | 0.014 | 0.006 | — | — | — | — | 100 | 100 | 100 | 100 |
| Ex2 | y-4 | 0.010 | 0.007 | 0.003 | — | — | c | c | 100 | 100 | 62 | 21 |
| Ex3 | | 0.020 | 0.014 | 0.006 | — | — | — | — | 100 | 100 | 100 | 100 |
| Ex4 | | 0.100 | 0.070 | 0.030 | — | — | — | — | 100 | 100 | 100 | 100 |
| Ex5 | y-5 | 0.010 | 0.006 | 0.004 | — | — | c | c | 100 | 100 | 58 | 19 |
| Ex6 | | 0.020 | 0.012 | 0.008 | — | — | — | — | 100 | 100 | 100 | 100 |
| Ex7 | | 0.100 | 0.060 | 0.040 | — | — | — | — | 100 | 100 | 100 | 100 |
| Ex8 | y-8 | 0.020 | 0.014 | 0.006 | — | — | — | — | 100 | 100 | 100 | 100 |
| Ex9 | y-9 | 0.020 | 0.014 | 0.006 | — | — | — | — | 100 | 100 | 100 | 100 |
| Ex10 | y-10 | 0.020 | 0.014 | 0.006 | — | — | — | — | 100 | 100 | 100 | 100 |
| Ex11 | y-11 | 0.020 | 0.014 | 0.006 | — | — | — | — | 100 | 100 | 100 | 100 |
| CEx1 | — | 0 | 0 | 0 | c | c | c | c | 44 | 0 | 0 | 0 |
| CEx2 | y-2 | 0.007 | 0.007 | 0 | — | c | c | c | 100 | 38 | 0 | 0 |
| CEx3 | | 0.010 | 0.010 | 0 | — | c | c | c | 100 | 72 | 11 | 0 |
| CEx4 | | 0.014 | 0.014 | 0 | — | — | c | c | 100 | 100 | 52 | 7 |
| CEx5 | | 0.020 | 0.020 | 0 | — | — | c | c | 100 | 100 | 60 | 17 |
| CEx6 | y-3 | 0.020 | 0.019 | 0.001 | — | — | c | c | 100 | 100 | 63 | 22 |
| CEx7 | y-6 | 0.020 | 0.008 | 0.012 | — | c | c | c | 100 | 70 | 13 | 0 |
| CEx8 | y-7 | 0.003 | 0 | 0.003 | c | c | c | c | 69 | 14 | 0 | 0 |
| CEx9 | | 0.006 | 0 | 0.006 | — | c | c | c | 100 | 35 | 0 | 0 |
| CEx10 | | 0.020 | 0 | 0.020 | — | c | c | c | 100 | 66 | 0 | 0 |

Ex: Example,
CEx: Comparative Example

The test result of the additive for granulated blast furnace slag of the present invention is shown in Table 5. Superior long-term anti-caking effect could be achieved by all of the additives for granulated blast furnace slag (Examples 12 to 14). Furthermore, it can be seen from the test results that the excessive mixture of entrapped air in mortar can be prevented by using the additive comparing to the case where the additive for granulated blast furnace slag is not used (Comparative Example 10).

TABLE 5

| | Additive for granulated blast furnace slag | | | | Specimen | | | | | | | | |
|---|---|---|---|---|---|---|---|---|---|---|---|---|---|
| | | Used amount (S × %) | | | Degree of | | | | Consolidation | | | | mortar |
| | | Entire | Anti-caking agent for | | consolidation | | | | prevention rate (%) | | | | air |
| | | constitutive | granulated blast | Anti-foaming | 7 | 14 | 28 | 56 | 7 | 14 | 28 | 56 | content |
| | kind | component | furnace slag | agent | days | days | days | days | days | days | days | days | (%) |
| Wx12 | z-1 | 0.0205 | 0.020 | 0.0005 | — | — | — | — | 100 | 100 | 100 | 100 | 0.5 |
| Ex13 | z-2 | 0.0205 | 0.020 | 0.0005 | — | — | — | — | 100 | 100 | 100 | 100 | 0.2 |
| Ex14 | z-3 | 0.0205 | 0.020 | 0.0005 | — | — | — | — | 100 | 100 | 100 | 100 | 0.3 |
| CEx10 | — | 0 | 0 | 0 | c | c | c | c | 44 | 0 | 0 | 0 | 3.0 |

### INDUSTRIAL APPLICABILITY

By using the anti-caking agent of the present invention, the consolidation that occurred during storage in a stockyard or during transportation by sea, etc., which had been a serious obstacle to the effective use of granulated blast furnace slag as the resources for aggregates, can be prevented for a long period of time. Another advantage of the anti-caking agent of the present invention, when it is used within a normal usage effective for preventing consolidation, is in that it can be added to granulated blast furnace slag without affecting the physical properties of the cement composition when using said slag as its fine aggregates. The present invention expands the effective use of the granulated blast furnace slag as the resources for aggregates, and contributes to the construction of the highly recycling-based society system for the symbiosis with the environment. Furthermore, the hard labor of crushing the consolidation with heavy machinery will no longer be necessary with the present invention, and therefore the present invention contributes to the reduction of cost and energy as well.

By using the additive for granulated blast furnace slag of the present invention, the consolidation of the granulated blast furnace slag and the excessive air entrapment in the cement composition obtained by using said slag as the fine aggregates can be prevented at the same time, and the complicated operation of controlling air content in the ready-mixed concrete factories can be remarkably facilitated.

1. An anti-caking agent for granulated blast furnace slag or a mechanically stabilized product thereof, characterized by containing components A and B below:
Component A: gluconic acid and/or a salt thereof;
Component B: copolymer and/or a salt thereof of C₅₋₆ chained olefin and one or more monomers selected from maleic anhydride, maleic acid or their esterified product, (meth)acrylic acid or its esterified product.

2. The anti-caking agent according to claim 1, wherein the mass ratio of said component A to component B is 90:10 to 50:50.

3. The anti-caking agent according to claim 1, wherein said component B is a copolymer with a number average molecular weight of 1000 to 300000 and/or a salt thereof.

4. A method for preventing the consolidation of granulated blast furnace slag or a mechanically stabilized product thereof, characterized by using an anti-caking agent comprising components A and B below in an amount of 0.001 to 0.1 part by weight based on 100 parts by weight of the granulated blast furnace slag or the mechanically stabilized product thereof;
Component A: gluconic acid and/or a salt thereof;
Component B: copolymer and/or a salt thereof of C₅₋₆ chained olefin and one or more monomers selected from maleic anhydride, maleic acid or their esterified product, (meth)acrylic acid or its esterified product.

5. The method for preventing consolidation according to claim 4 using 0.1 to 10% by weight aqueous solution of the anti-caking agent.

6. Granulated blast furnace slag or a mechanically stabilized product thereof containing an anti-caking agent comprising components A and B below:
Component A: gluconic acid and/or a salt thereof;
Component B: copolymer and/or a salt thereof of C₅₋₆ chained olefin and one or more monomers selected from maleic anhydride, maleic acid or their esterified product, (meth)acrylic acid or its esterified product.

7. An additive for granulated blast furnace slag or a mechanically stabilized product thereof, characterized by containing component (II) below:
Component (II): anti-foaming agent selected from one or more kinds based on block and/or random copolymer of polyethylene oxide and propylene oxide, silicone, mineral oil, alcohol, fatty acid ester, and polyether.

8. An additive for granulated blast furnace slag or a mechanically stabilized product thereof, characterized by containing components (I) and (II) below:
Component (I): anti-caking agent for granulated blast furnace slag;
Component (II): anti-foaming agent selected from one or more kinds based on block and/or random copolymer of polyethylene oxide and propylene oxide, silicone, mineral oil, alcohol, fatty acid ester, and polyether.

9. A method for preventing excess air entrapment in a cement composition, characterized by using an additive containing components (I) and (II) below:
Component (I): anti-caking agent for granulated blast furnace slag;
Component (II): anti-foaming agent selected from one or more kinds based on block and/or random copolymer of polyethylene oxide and propylene oxide, silicone, mineral oil, alcohol, fatty acid ester, and polyether.

10. The anti-caking agent according to claim 2, wherein said component B is a copolymer with a number average molecular weight of 1000 to 300000 and/or a salt thereof.
